(19) United States
(12) Patent Application Publication
(10) Pub. No.: US 2002/0082990 A1
(43) Pub. Date: Jun. 27, 2002

(54) Method of invoice presentation and payment

(75) Inventor: Floyd J. Jones, Plymouth, MI (US)

Correspondence Address: Jeremy J. Curcuri, Brooks & Kushman P.C., Twenty-Second Floor, 1000 Town Center, Southfield, MI, 48075, US

(73) Assignee: J.J. & Associates Inc., Detroit, MI (US)

(21) Appl. No.: 09/747,863

(22) Filed: Dec. 22, 2000

(51) Int. Cl. G06F 17/60

(52) U.S. Cl. 705/40; 705/34

(57) ABSTRACT

A method of invoice presentation and invoice payment for use in a network accessible to a biller having an accounts receivable system and a biller bank, and accessible to a payer having an accounts payable system and a payer bank is provided. The method includes establishing a database accessible over the network. An invoice is exported from the biller accounts receivable system to the database. The invoice is presented to the payer when the payer accesses the database to view the invoice. The invoice is imported to the payer accounts payable system from the database. The invoice is paid by recording a payment from the payer representing an amount of money. The payment is recorded in the database. The payment is imported to the payer accounts payable system from the database. The payment is imported to the biller accounts receivable system from the database.

### TECHNICAL FIELD

The present invention relates to a method of invoice presentation and invoice payment for use in a network accessible to a biller having a biller accounts receivable system and a biller bank, and accessible to a payer having a payer accounts payable system and a payer bank.

### BACKGROUND ART

Electronic commerce, including the business-to-business market, is growing. Many processes that have previously been performed manually, are now being performed electronically.

U.S. Pat. No. 5,677,955 describes an electronic funds transfer instrument in which the electronic instrument includes an electronic signature of the payer, digital representations of payment instructions, the identity of the payer, the identity of the payee, and the identity of the funds-holding institution. U.S. Pat. No. 5,699,528 describes a system and method for bill delivery and payment over a communications network. U.S. Pat. No. 5,832,460 describes a method and system for bill presentation and payment reconciliation. U.S. Pat. No. 5,884,288 describes a method and system for electronic bill payment. U.S. Pat. No. 6,052,674 describes an electronic invoicing and collection system and method with charity donations. U.S. Pat. No. 6,055,567 describes a distributed data accessing technique. And, U.S. Pat. No. 6,078,907 describes a method and system for electronically presenting and paying bills.

Although each of these existing systems describes an improvement over previous systems at the relevant time, even these systems have their shortcomings. E-commerce has been growing rapidly, but yet, is still in its infancy. Many existing electronic billing methods focus entirely on the biller side of the transaction, providing only a partial solution for billing and payment processes.

For the foregoing reasons, there is a need for an improved method of invoice presentation and invoice payment that improves over existing systems and that provides a complete solution for billing and payment processes.

### DISCLOSURE OF INVENTION

It is, therefore, an object of the present invention to provide a method of invoice presentation and invoice payment for use in a network that cooperates with both the biller accounts receivable system and the payer accounts payable system to provide a full solution to existing and future billing and payment processes.

In carrying out the above object, a method of invoice presentation and invoice payment for use in a network accessible to a biller having a biller accounts receivable system and a biller bank, and accessible to a payer having a payer accounts payable system and a payer bank, is provided. The method comprises establishing a database accessible over the network. An invoice is exported from the biller accounts receivable system to the database. The invoice is presented to the payer when the payer accesses the database to view the invoice. The invoice is imported to the payer accounts payable system from the database. The method further comprises paying the invoice by recording a payment from the payer representing an amount of money, with the payment being recorded in the database. The payment is imported to the payer accounts payable system from the database. The payment is imported to the biller accounts receivable system from the database.

Preferably, the method further comprises transmitting the payment from the database to the biller bank, and transferring the amount of money to the biller bank from the payer bank. Preferably, the database is established such that the database is accessible over the Internet. Alternatively, a different network may be utilized. More preferably, the database is accessible over the network through a web executable interface. The web executable interface preferably operates in a virtual machine. The payer starts the virtual machine and interacts with the database from within the virtual machine.

In a preferred embodiment, presenting the invoice to the payer further comprises starting the virtual machine at the payer, and presenting the invoice to the payer with the virtual machine. Paying the invoice further comprises paying the invoice as directed by the payer from within the virtual machine. More preferably, importing the invoice to the payer accounts payable system further comprises downloading the invoice from the payer as directed by the payer from within the virtual machine, and importing the downloaded invoice. More preferably, importing the payment to the payer accounts payable system further comprises downloading the payment from the database as directed by the payer from within the virtual machine, and importing the downloaded payment.

Preferably, both the payer side and the biller side of the system are interfaced with through a web executable interface that operates in a virtual machine. Preferably, the biller starts the virtual machine and interacts with the database from within the virtual machine. In a preferred embodiment, the biller views the recorded payment from within the virtual machine. More preferably, importing the payment to the biller accounts receivable system further comprises downloading the payment from the database as directed by the biller from within the virtual machine, and importing the downloaded payment. More preferably, exporting the invoice from the biller accounts receivable system further comprises uploading the invoice as directed by the biller and entering the uploaded invoice into the database. In preferred embodiments, the invoice may have one or more associated attachments, and the method further comprises uploading the at least one attachment as directed by the biller, and entering the uploaded at least one attachment into the database.

In addition to the preferred features mentioned above, preferred embodiments of the present invention include payer and biller notification. A preferred method further comprises notifying the payer when the invoice is exported from the biller accounts receivable system to the database. Notifying the payer may be performed by sending an e-mail to the payer to notify the payer when the invoice is exported from the biller accounts receivable system to the database. Further, preferred methods include notifying the biller when the payment is recorded. The biller may be notified by sending an e-mail to the biller to notify the biller when the payment is recorded.

In a preferred implementation, on the payer side of the system, the method comprises approving the invoice prior to paying the invoice. In this way, the interface to the payer may be structured such that a different person approves bills than the person that makes payments. After a payment is recorded, the method further comprises applying the payment to the invoice. Preferably, the payment is applied to the invoice in accordance with predefined payment rules set up by the biller.

The advantages associated with embodiments of the present invention are numerous. An embodiment of the present invention may be employed to provide an electronic bill presentation and payment portal for the business-to-business market. Customers receive bills online and make payments utilizing credit cards, electronic checks, or electronic fund transfers. The web executable interface allows the presenting of uploaded invoices, and the making of payments online. Advantageously, preferred methods of the present invention load payment information back into the accounts receivable system and accounts payable system of the biller and the payer, respectively, to provide a complete solution.

The above object and other objects, features, and advantages of the present invention will be readily appreciated by one of ordinary skill in the art in the following detailed description of the best mode for carrying out the invention when taken in connection with the accompanying drawings.

### BRIEF DESCRIPTION OF DRAWINGS

FIG. 1 is a block diagram illustrating the cooperation of various components to perform a method of invoice presentation and invoice payment in accordance with the present invention;

FIG. 2 is a block diagram illustrating a preferred method of the present invention;

FIGS. 3-10 illustrate various aspects of an exemplary web executable interface as seen by a payer in accordance with the present invention; and

FIGS. 11-17 illustrate various aspects of an exemplary web executable interface as seen by a biller in accordance with the present invention.

### BEST MODE FOR CARRYING OUT THE INVENTION

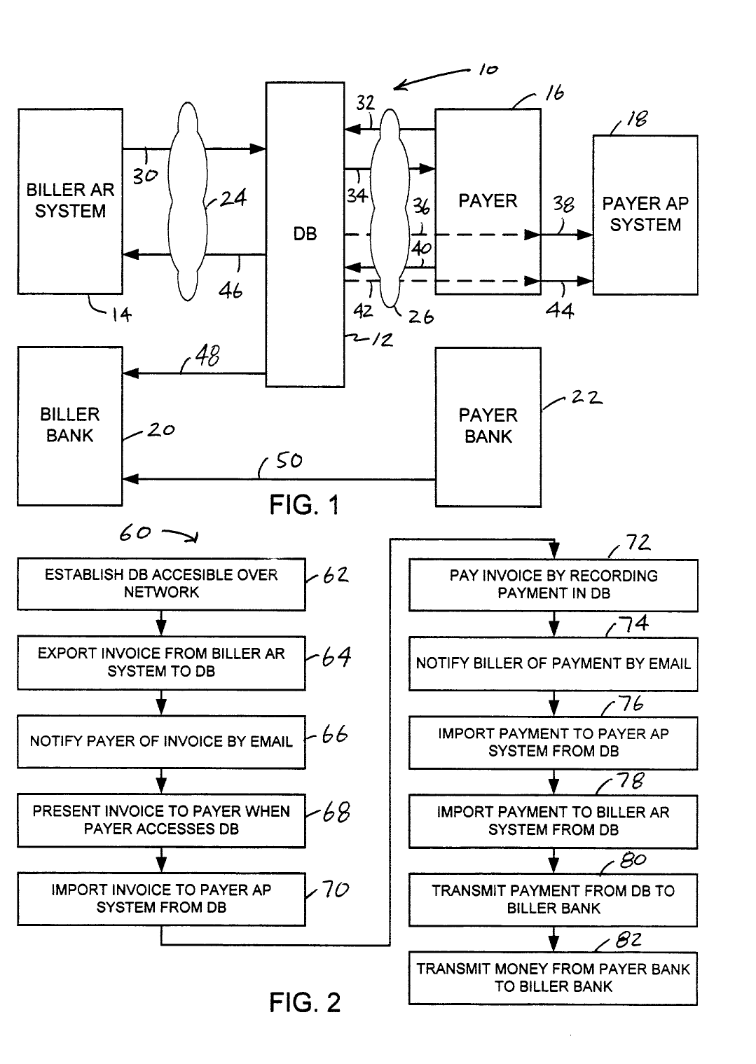

With reference to FIG. 1, the cooperation of various components in carrying out a method of invoice presentation and invoice payment over a network in accordance with the present invention is generally indicated at 10. A host system that directs and controls the overall process includes a database 12. A biller accounts receivable system 14 has access to database 12. A payer 16 also has access to database 12. A payer accounts payable system 18 is used by payer 16. Advantageously, the present invention involves both the biller side and the payer side of the invoice presentation and payment process. A biller bank 20 receives payments transmitted from the database 12. Biller bank 20 does the actual transferring of funds from payer bank 22 in accordance with the payment file received by biller bank 20 from database 12. In preferred embodiments, database 12 is accessible over networks 24 and 26, which may be part of the Internet. Of course, it is appreciated that other suitable networks may be utilized in addition to or as an alternative to the Internet. With continuing reference to FIG. 1, and with reference to the block diagram generally indicated at 60 in FIG. 2, a preferred method of the present invention includes establishing a database 12 accessible over a network (block 62). As indicated by arrow 30, an invoice is exported from biller AR system 14 to database 12 (block 64). In preferred embodiments, payer 16 is notified when the invoice arrives at database 12. Notification may occur via e-mail or any other suitable technique (block 66). When payer 16 accesses database 12 as indicated by arrow 32, the invoice is presented to the payer 16 as indicated by arrow 34 (block 68). When desired, payer 16 may import the invoice to payer AP system 18 as indicated by arrows 36 and 38 (block 70).

Payer 16 pays the invoice by recording a payment in database 12 as indicated by arrow 40 (block 72). When payment is made, the biller may be notified any suitable technique such as e-mail (block 74).

In accordance with the present invention, payer AP system 18 is updated with information from database 12, in addition to the updating of biller AR system 14 with information from database 12. As mentioned above, invoices are imported to payer AP system 18. In addition, payer AP system 18 may import payments from database 12 as indicated by arrows 42 and 44 (block 76). As indicated by arrow 46, the payment is also imported by biller AR system 14 (block 78).

At this point, the method of the present invention has provided the exporting of the invoice from the biller AR system to the database, the importing of the invoice to payer AP system 18, the payment of the invoice, and the importing of the payment to payer AP system 18. Further, the method provides the importing of the payment to biller AR system 14 to synchronize biller AR system 14, database 12, and payer AP system 18. Although there are some existing bill presentation and payment systems that function on the biller side, the present invention, for the very first time, allows both the biller AR system 14 and the payer AP system 18 to cooperate with database 12 via the Internet. In addition, database 12 may be located separately from biller AR system 14 and payer AP system 18 and function as a portal. On the other hand, it is not required that database 12 be physically separated from biller AR system 14 even though it is preferred. The separate database 12 may function as a payment portal allowing numerous billers and numerous payers to interface therewith.

To complete the transaction, preferred embodiments of the present invention transmit payment from database 12 to biller bank 20 as indicated by arrow 48 (block 80). And lastly, payer bank 22 transmits money to biller bank 20 as indicated by arrow 50 (block 82).

Methods of the present invention for invoice presentation and invoice payment involve both biller AR system 14 and payer AP system 18. Database 12 may be accessed through a network server. It is appreciated that any number of biller AR systems and any number of payer AP systems and associated billers and payers may interact with database 12. Further, accordingly, there may be any number of different biller and payer banks. Interactions with database 12 preferably take place through a web executable interface. A web executable interface may take many forms, but preferably is an interface that runs in a virtual machine environment. The remaining figures illustrate an exemplary virtual machine environment along with an exemplary presentation of information from database 12 and exemplary interactions with database 12. Of course, it is appreciated that the broad method described in FIGS. 1 and 2 may be implemented in many ways and the remaining figures are not to be construed as limiting.

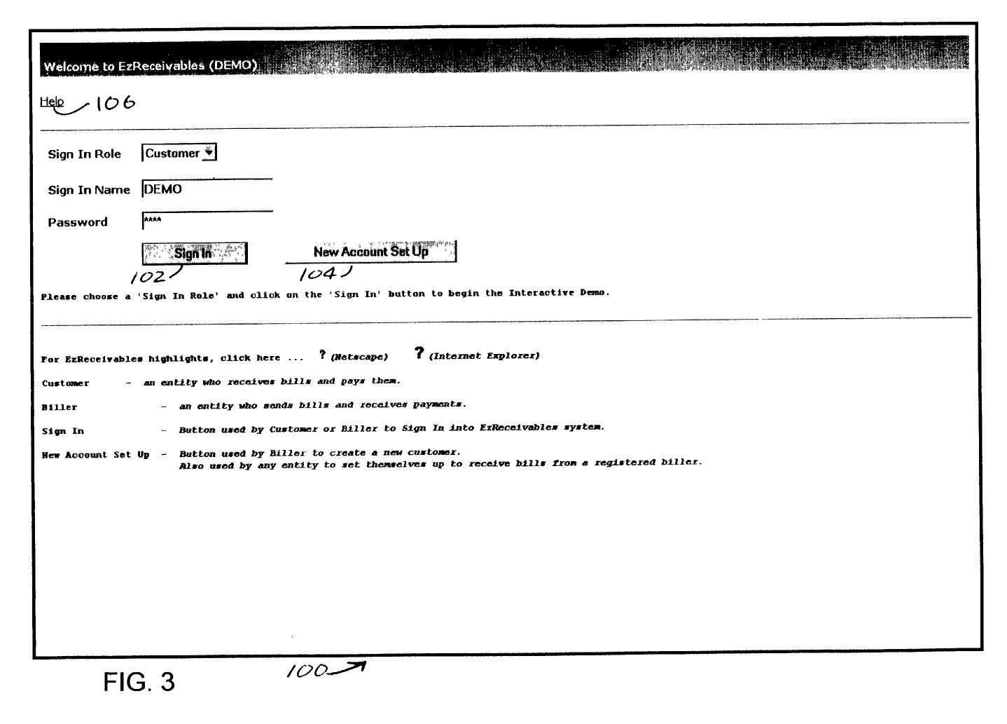

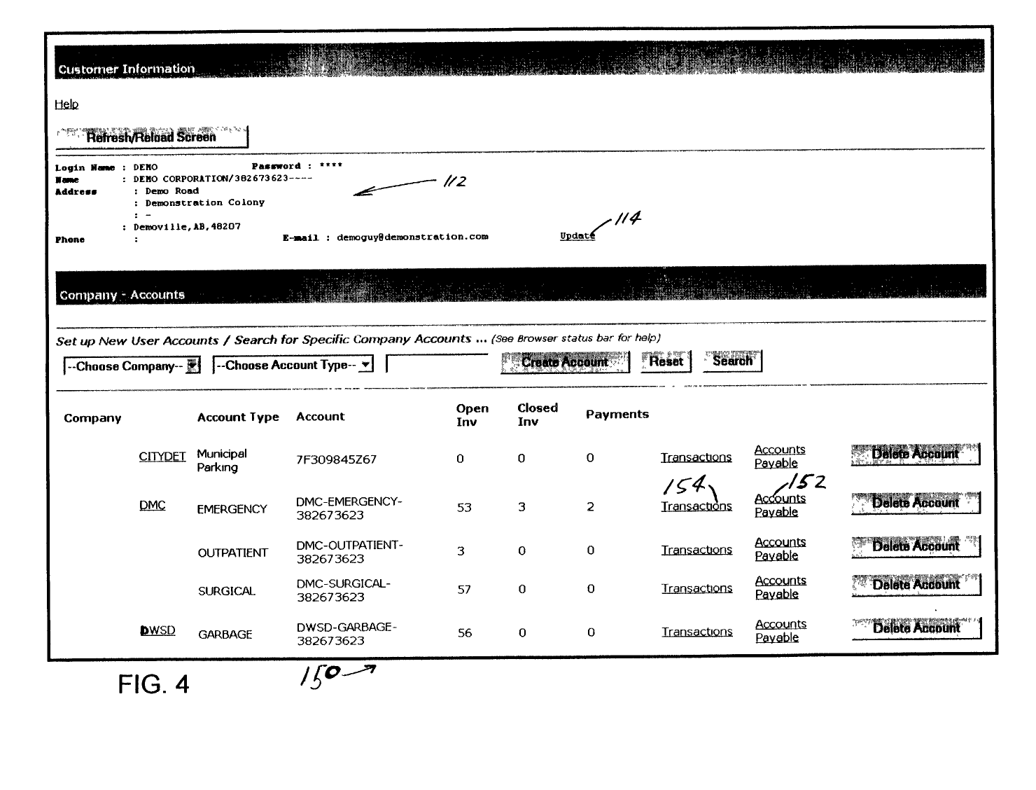

FIGS. 3-10 illustrate the interactions of a payer with the database. Preferably, these interactions take place through a web executable interface that runs in a virtual machine and inside a browser window so that the forward and back buttons of the browser may be used to help navigate. For the payer to be able to interact with the database, the payer must register through a registration process that may be an online registration process. In addition, the payer must be receiving bills from billers that are registered with the host system. When these conditions are present, the payer may log on to the system as shown in the exemplary log on screen generally indicated at 100 in FIG. 3. Also shown in FIG. 3 are: sign in button 102, new account setup button 104, and help link 106. In FIG. 4, the screen shot is generally indicated at 150. For the particular payer that has signed onto the system, account numbers, associated billing companies, and associated account types are shown. For each account number, a link 152 allows the payer to access the accounts payable system options. Another link 154 shows the invoices and payments for the particular account number corresponding to the link 154 that is pressed.

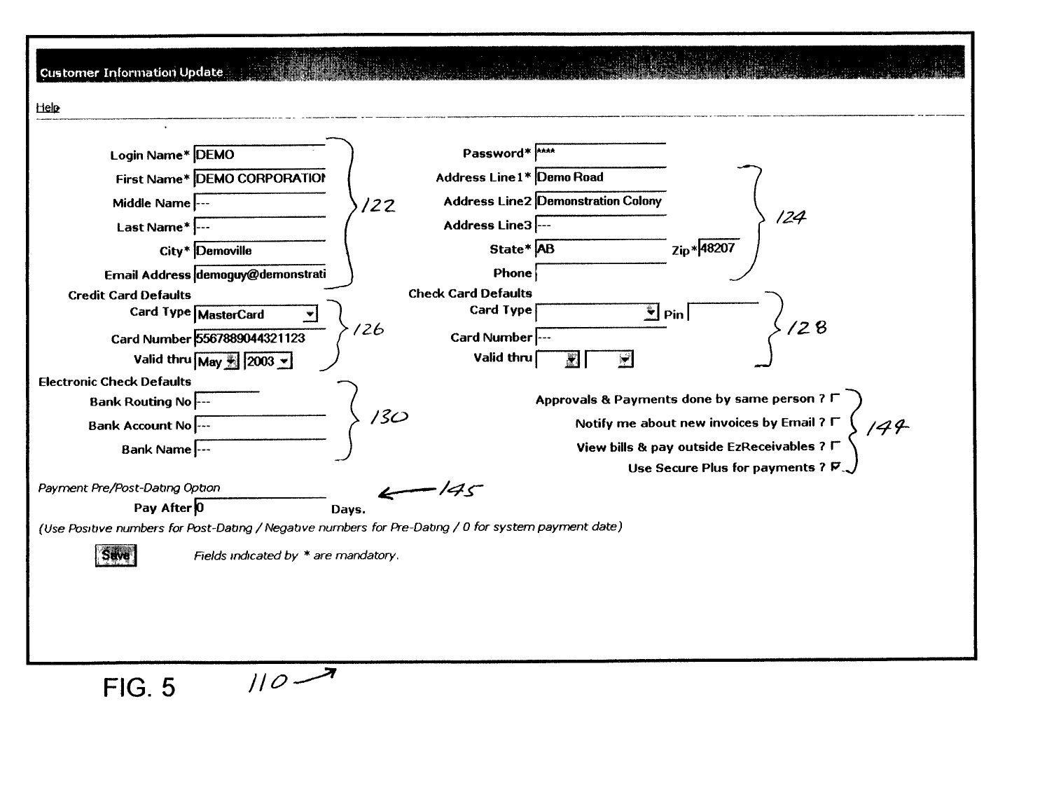

Payer information is indicated at link 112, and link 114 leads to customer information update screen 110 in FIG. 5. In FIG. 5, billing contact information is indicated at 122 while billing address is indicated at 124. The payer also has quick pay options, that is, default payment methods that may be entered here. Credit card defaults are entered at 126, check card defaults are entered at 128, and electronic check defaults are indicated at 130. Again, it is appreciated that the interface illustrated herein is exemplary and that many modifications may be made thereto without departing from the true invention described here. As indicated at 144, the payer may choose from various business process options. For example, the system allows approvals and payments to be done by either the same person or different persons with different login names or using some other technique to differentiate the approver from the payer. As such, when different persons do the approvals and payments, the payer may not make a payment until the invoice has been approved by the approver. There is also a process option for e-mail notification of new invoices, as well as an option to use the system only for viewing bills (do not use the system for paying bills). Also, a payment Pre/Post dating option is provided as indicated at 145. Lastly, a security option is provided.

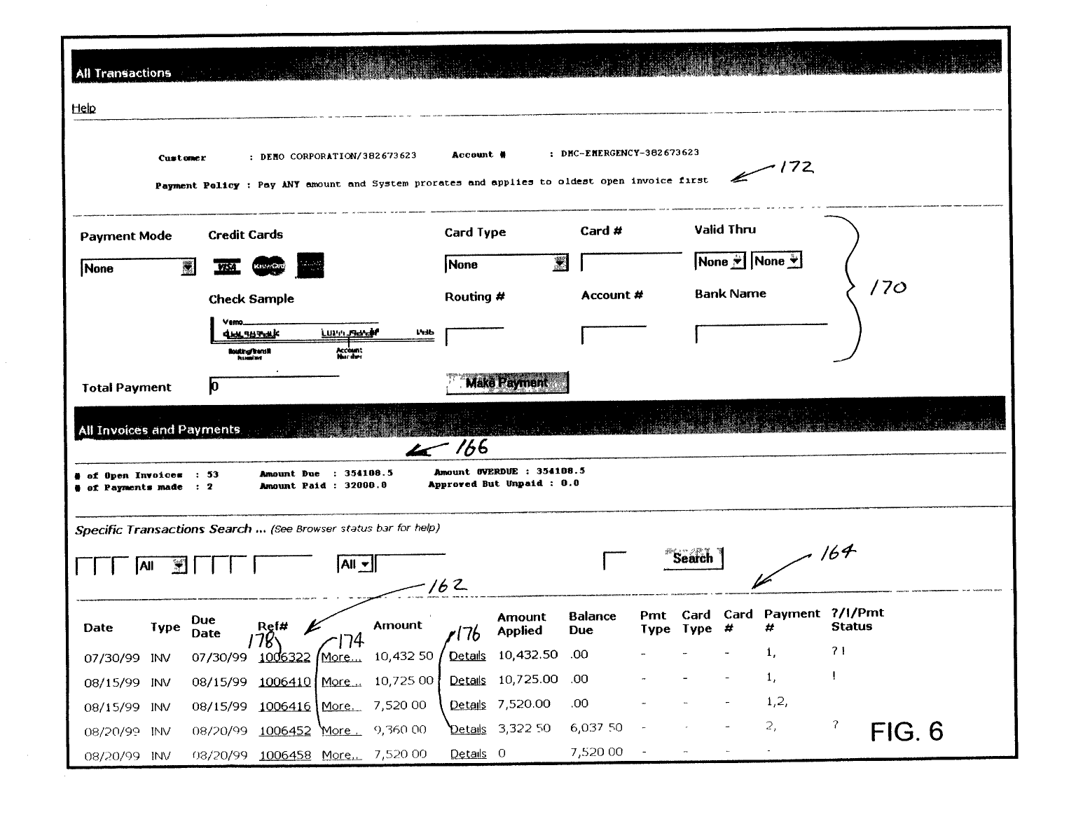

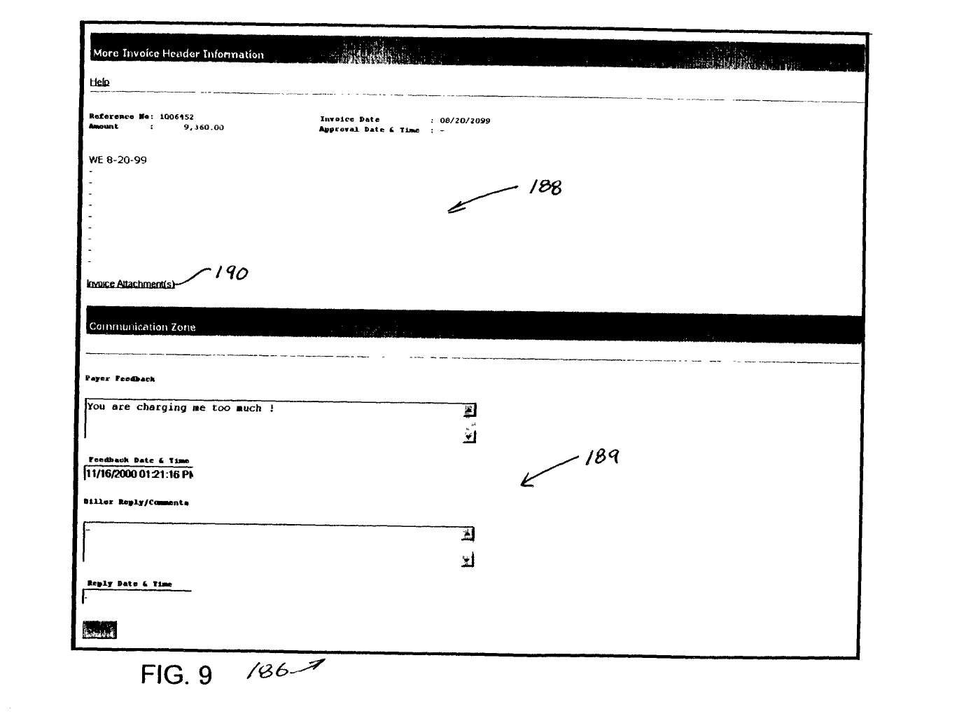

As shown in FIG. 6, detailed invoice and payment information is illustrated. At 162, the invoices and payments are indicated, and at 164, payment details are indicated. Summary information is indicated at 166. Payment and application rules for the specific account are indicated at 172. Payment information 170 allows the user to make a payment by entering the appropriate information in the space provided. Link 174 brings up information on the invoice header that is not shown in FIG. 6. (It is shown in FIG. 9.) Link 176 brings up invoice details for a particular invoice or payment, and link 178 prints a particular invoice or a particular payment.

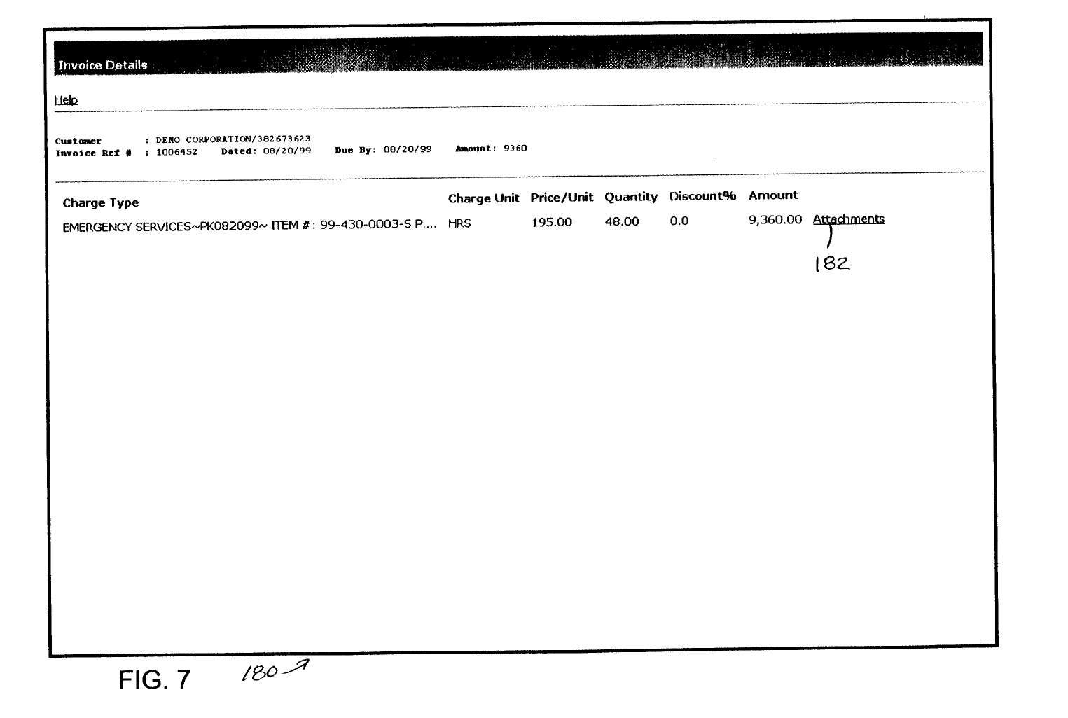

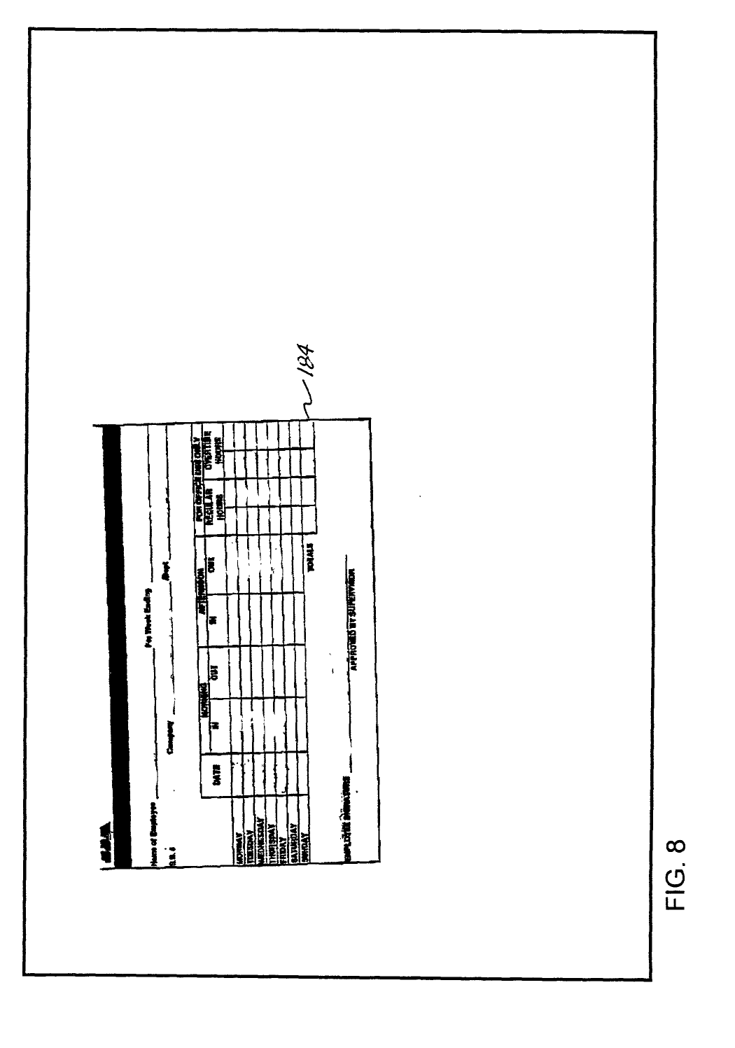

For a particular invoice listed in the invoices and payments tab, invoice details may be viewed as shown in screen shot 180 of FIG. 7 (by pressing link 176). The invoice details may include any details provided by the biller in addition to any number of associated attachments. The attachments may be, for example, a scanned copy of the actual invoice. An attachment is viewed by pressing the attachment button 182. As shown in FIG. 8, an attachment 184 is shown (some details of the attachment are omitted). In FIG. 9, screen 186 illustrates the additional header information viewed by pressing link 174. In addition to header information 188, optional feedback section 189 may be included. Also a way of looking at invoice level attachment (link 190) is provided.

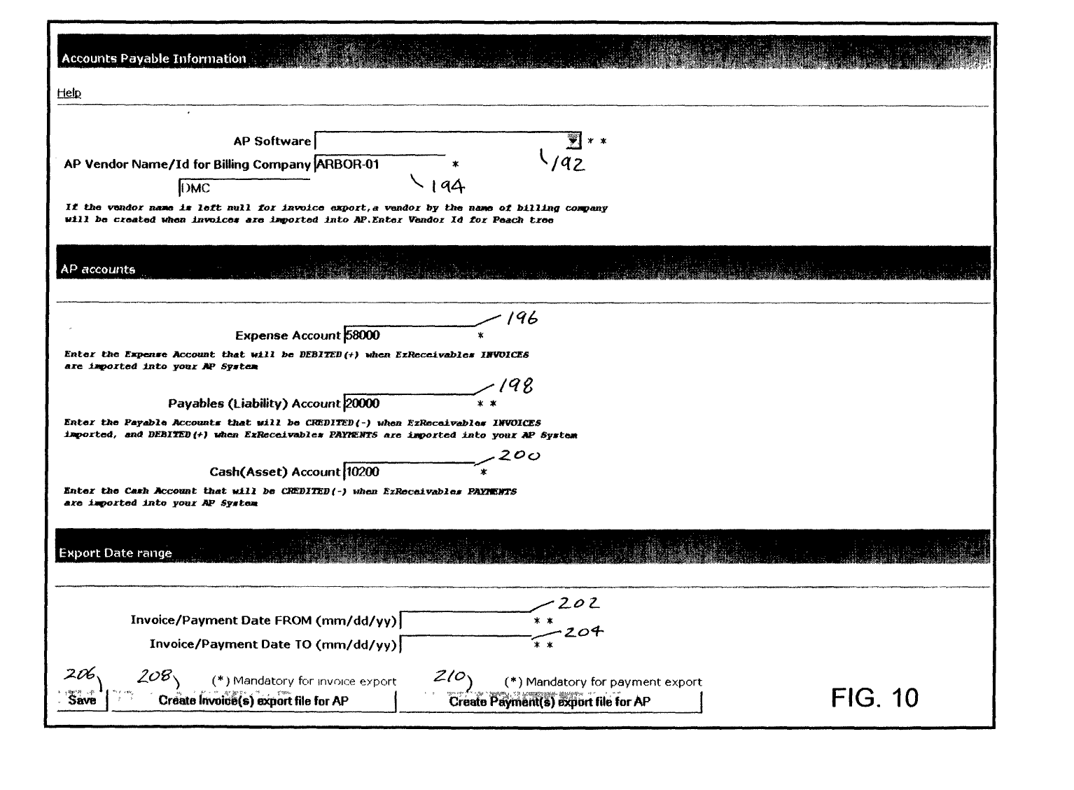

As shown in FIG. 10, the accounts payable information is indicated in a pop-up window when accounts payable link 152 of FIG. 4 is followed. Recall that the host system, database, and interface of the present invention are provided, among other reasons, to allow the payer to view and pay invoices online and to download invoices and payments to the payer AP system (sometimes referred to as the payer in-house system). In accordance with the present invention, the host system, database, and interface interact with the biller, payer, biller AR system and payer AP system. The biller and payer in-house systems may run any accounting software so long as the import/export file format for the particular accounting software is supported by the host system. At this time, the host system is designed to support several of the more popular file formats. The screen shown in FIG. 10 allows the payer to set up information that corresponds to the set up in their in-house accounts payable system. The payer may set up the system to correspond with their own accounts payable system and then run jobs to extract invoices and payments from the system database. The extracted files may then be imported into the payer's accounts payable system.

Of course, the FIG. 10 screen is exemplary, and other suitable techniques may be utilized for configuring the database exports for ready acceptance into the payer's accounts payable system. Specifically, in the example at block 192, the payer selects the name of their in-house software package from the pull down menu so that the host system can export invoices and payments in the proper file format. Preferably, the host system is capable of outputting files in formats accepted by several of the more popular commercially used accounting software packages. At block 194, vendor name is entered. Of course, it is appreciated that vendor name, as well as any of the other fields shown may be either required or optional, depending on the specific requirements of the accounts payable software selected in block 192. At blocks 196, 198, 200, the various accounts payable accounts that are to be debited and credited are entered. The expense account and payables account are debited and credited, respectively, when an invoice is imported. The payables account and cash account are debited and credited, respectively, when a payment is imported into the accounts payable system. Lastly, at blocks 202 and 204, the export data range is entered. The payer may press button 206 to save these settings. The payer may press button 208 to create an invoice export file. The payer may press button 210 to create a payment export file. In a suitable implementation, pressing button 208 or 210 gives the payer the option to download and save the export file to disk on the local computer. Afterward, the payer may open their AP system software and import the saved file. The particular steps to import the saved file to the payer accounting software may vary depending on the software package being used by the payer. Further, some packages may allow direct importing without requiring the file to be saved to disk first.

Above, and in FIGS. 3-10, the payer side interactions with database 12 for a preferred embodiment of the present invention have been described. It is appreciated that the web interface shown is exemplary, and other techniques may be utilized for exchanging information with database 12.

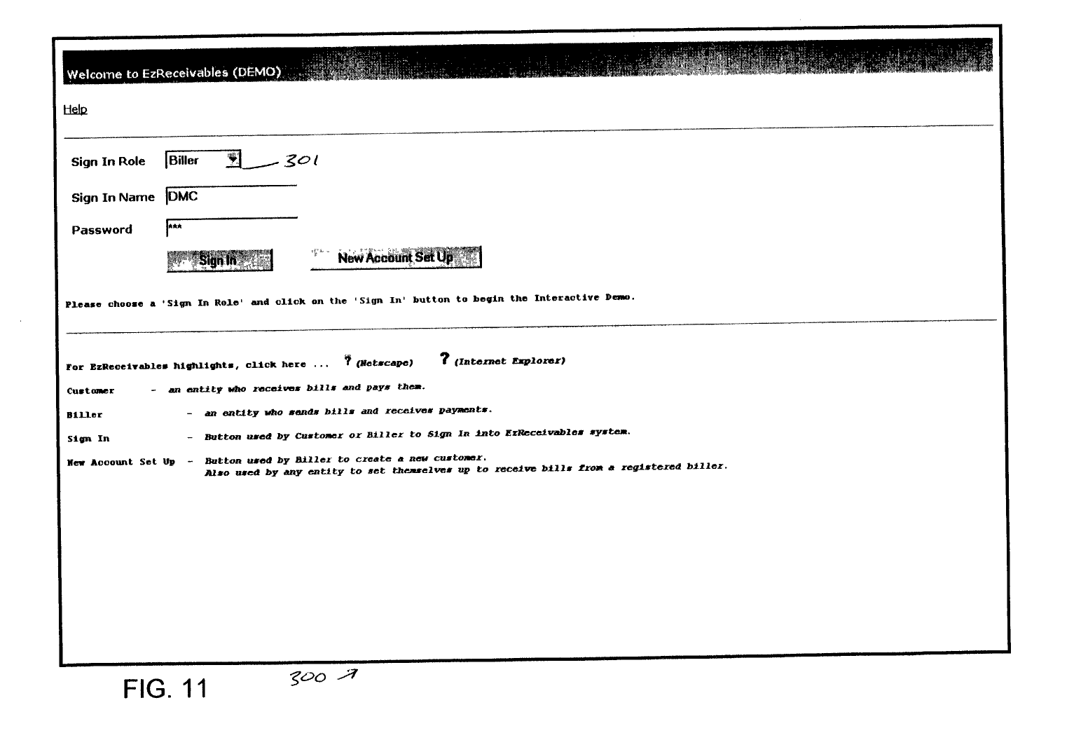

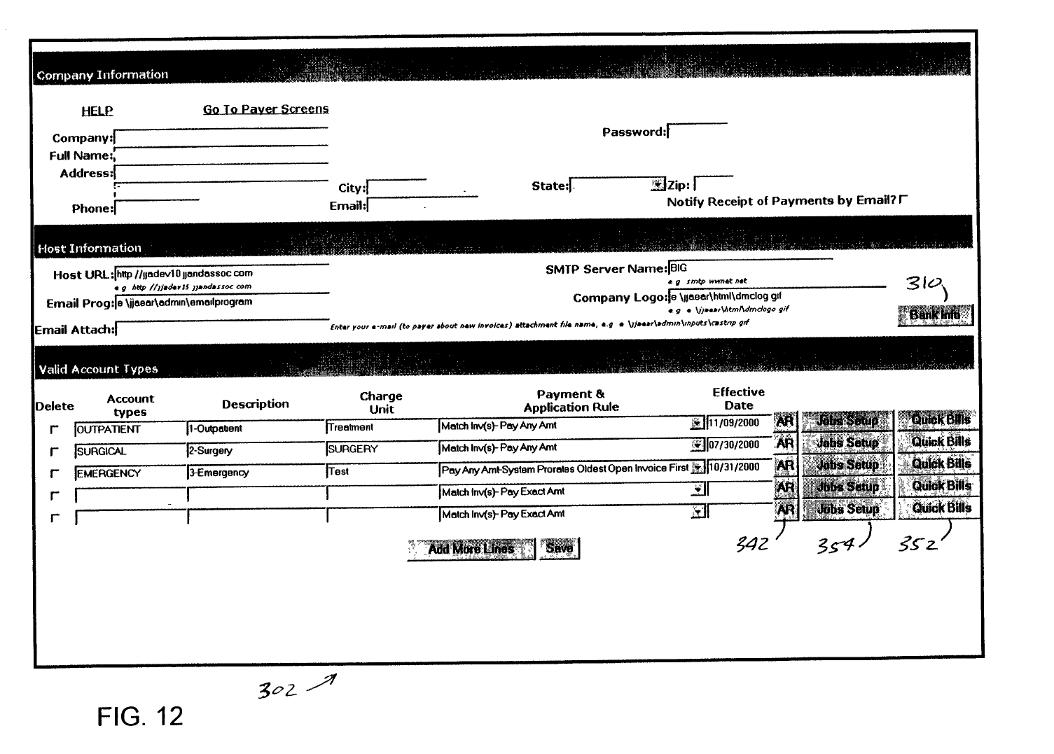

FIGS. 11-17 illustrate the interactions of a biller with the database. Preferably, these interactions take place through a web executable interface that runs in a virtual machine. For the biller to be able to interact with the database, the biller must register through a registration process that may be an online registration process. In addition, the biller must be receiving payments from payers that are registered with the host system. When these conditions are present, the biller may log onto the system as shown in the exemplary log-on screen generally indicated at 300 in FIG. 11. When the biller logs on to the system, the biller is indicated in box 301. In FIG. 12, once the biller has logged onto the host system, biller information screen 302 is presented.

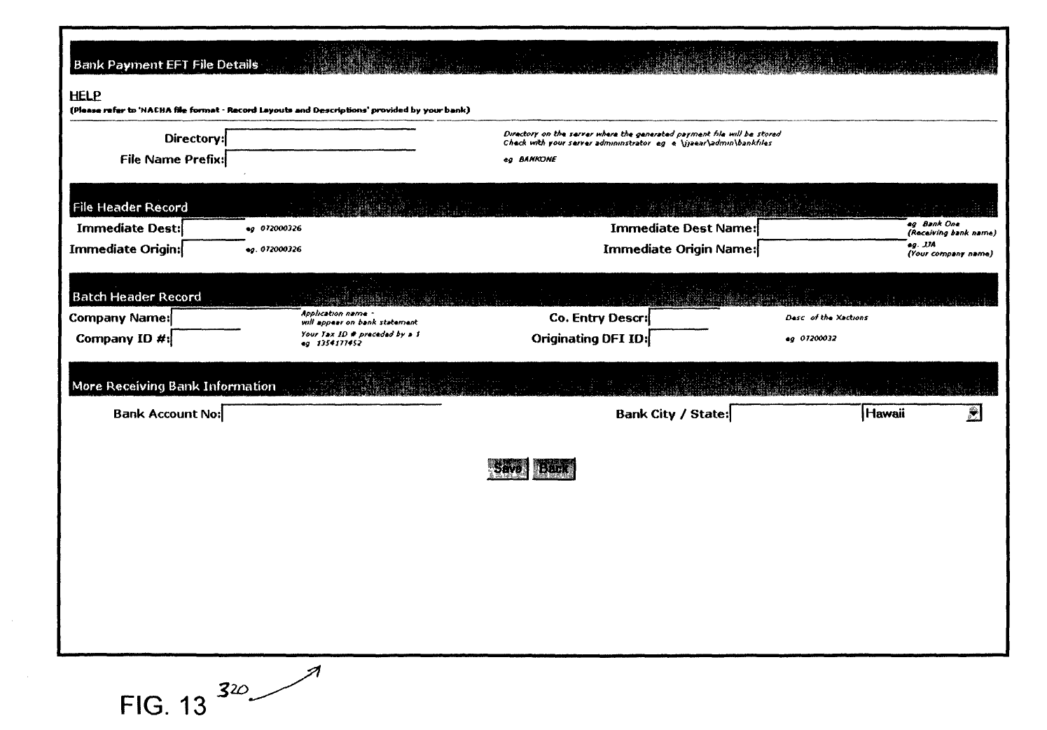

With continuing reference to FIG. 12, screen 302 includes company information 304, including a process option for e-mail notification of receipt of payments. Host information 306 is also included on screen 302. The host system administrator enters the appropriate information in the host information area 306 and the biller does not need to modify this information. As shown, the biller sends a company logo image file to the system administrator, and the system administrator may enter the logo file information into information 306. In turn, the logo may be used in conjunction with invoices uploaded to the database by the biller such that the logo is presented to the payer along with the invoice. Valid account types 308 are also indicated in screen 302. By pressing button 310, additional information may be viewed. Screen 320 of FIG. 13 illustrates additional information viewed by pressing button 310 of FIG. 12. In screen 320, detailed information for electronic funds transfer file details is shown. It is appreciated that payments may take many forms, in the event that a payment is an electronic fund transfer, the information in screen 320 is utilized to send the electronic fund transfer to the biller bank. Of course, the present invention is not limited to any specific types of payment, and screen 320 is merely shown as an exemplary portion of the exemplary interface.

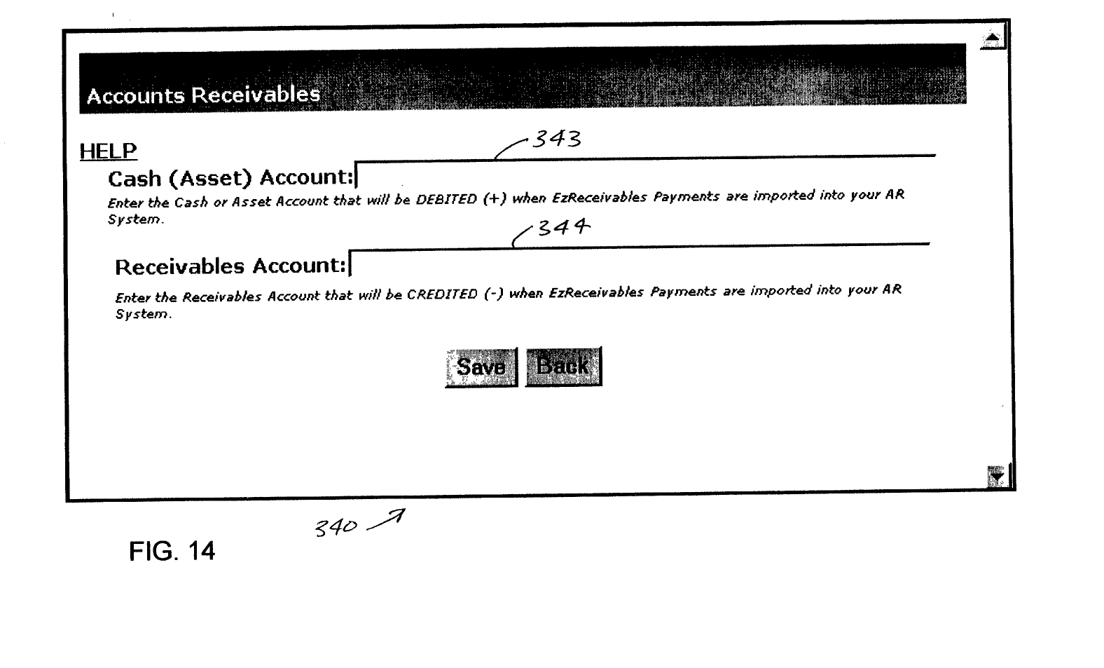

In FIG. 14, screen 340 illustrates accounts receivable information that is viewed by pressing button 342 in FIG. 12. The accounts receivable information that will be shown corresponds to the account for which the AR button 342 is pressed. As shown in FIG. 14, the accounts receivable information is indicated in a pop-up window and allows the biller to enter information that corresponds to the setup in their in-house accounts receivable system. The biller may setup the system as shown in screen 340 to correspond with their own accounts receivable system and then run jobs to extract payments from the system database. The extracted files may then be imported into the biller's accounts receivable system. Of course, screen 340 is exemplary, and other suitable techniques may be utilized for configuring the database exports for ready acceptance into the biller's accounts receivable system. Specifically in the example, at block 343, the biller selects the name of the cash or asset account that will be debited when payments are imported into the AR system. At block 344, the biller selects the receivables account that will be credited when payments are imported into the AR system. Preferably, although not specifically shown, the payer may select the name of their in-house software package so that the host system can export payments in the proper file format. Again, the host system is capable of outputting files in formats accepted by several of the more popular commercially used accounting software packages. Alternatively, the host system may detect the accounts receivable accounting software that is being used on the biller's local machine and then export the appropriate file type. Further, in the alternative, a standard file format may be utilized with the accounting software being programmed to accept the standard format.

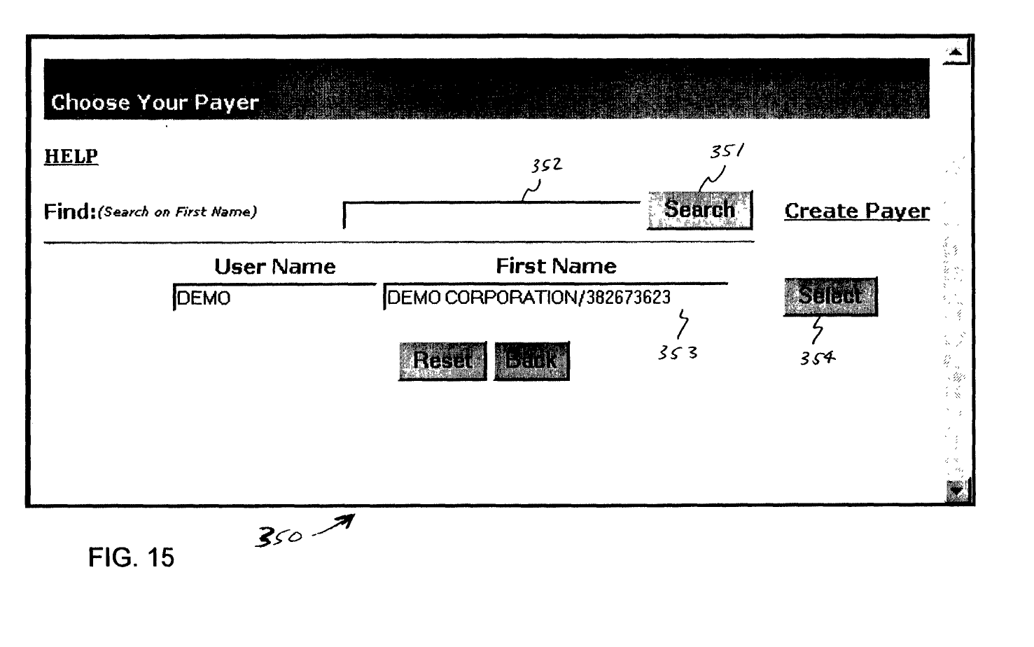

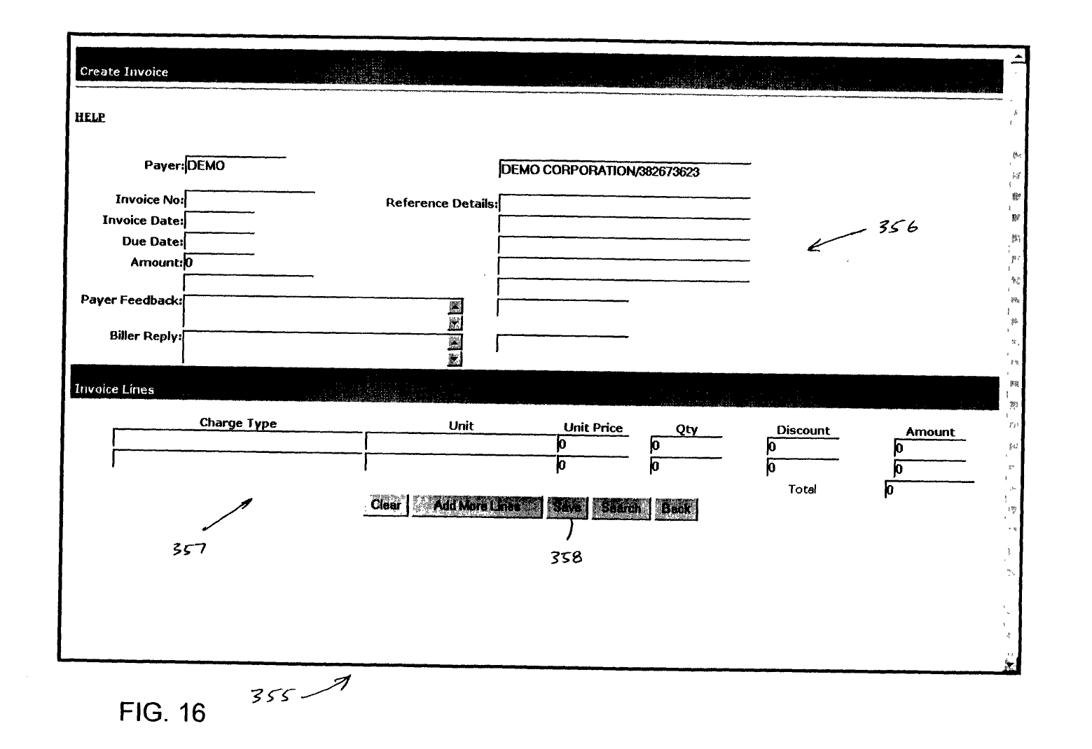

Screen 350 of FIG. 15 is accessed by pressing button 352 of FIG. 12. Screen 350 allows the biller to create/update/delete invoices while on-line with the system as opposed to importing invoices from the biller accounts receivable system. Button 351 causes the system to search for a payer with the name entered in block 352. When the correct payer appears in block 353, button 354 advances to screen 355 of FIG. 16. The biller fills out general information items 356 and invoice lines 357 before pressing button 358 to save the invoice to the system. The next time the specific payer logs on, the new invoice will be present. Invoices created on the system may be exported along with payments, or additional export invoice options may be provided. It is appreciated by those skilled in the art that various modifications to the file importing and exporting implementation may be made while still within the bounds of the present invention.

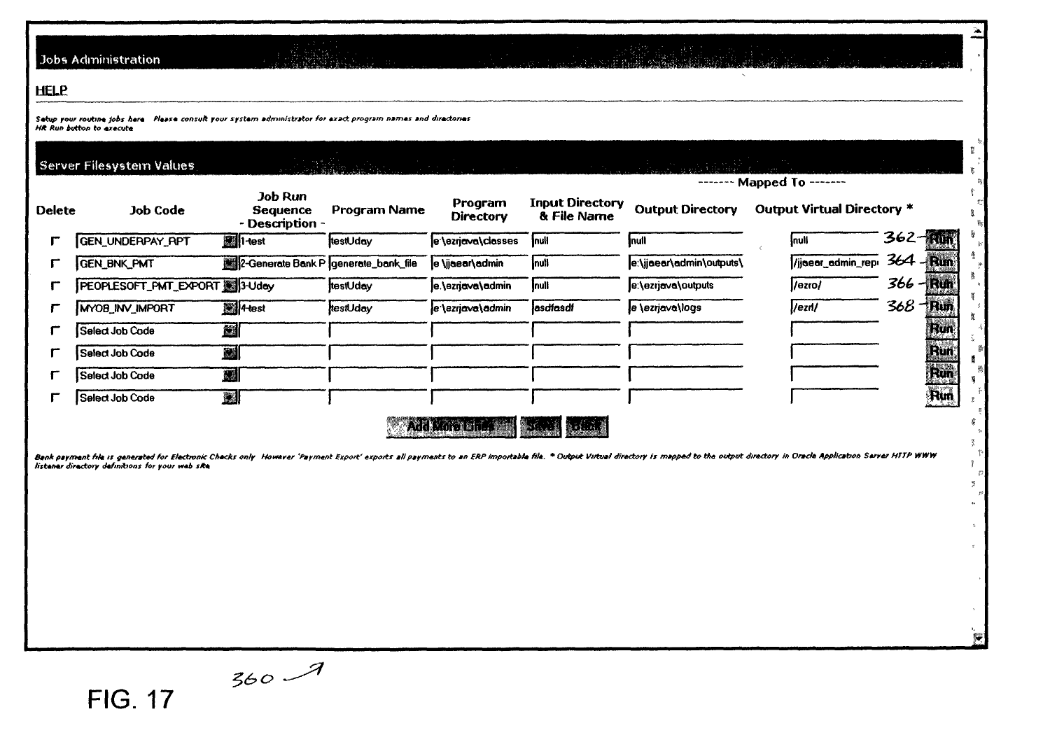

In FIG. 12, button 354 is pressed to enter the jobs administration screen, indicated at 360 in FIG. 17. Again, it is to be appreciated that methods of the present invention may be implemented in many ways and that the web executable interface example illustrated herein is an exemplary implementation. In FIG. 17, the various jobs may be implemented in many different ways and the explanation given below is of an exemplary implementation. In the example, button 362 is pressed by the biller to import invoices into the database. In a suitable implementation, the biller first uploads the invoices to a directory at the host system, and then logs into the system and presses button 362 to import the uploaded invoice to the database. The invoices may be uploaded using, for example, file transfer protocol (FTP). Button 364 is pressed to generate a payment file. That is, payers that log onto the system and make payments leave electronic payment files on the system representing those payments. The biller then, in a suitable implementation, must log onto the system and press button 364 to generate the payments. The payment files may take many forms such as, for example, North American Clearance House Association (NACHA) format. Alternatively, payments may be periodically automatically made by the system. Button 366 is pressed to export payments to the biller AR system. In a suitable implementation, pressing button 366 causes the payments to be downloaded to the biller local machine. Thereafter, the biller may import the payment files to the biller accounting software. This is similar to the exporting of invoices and payments by the payer, described above. Button 368 is pressed to generate unreplied feedback reports. In a suitable implementation, buttons 362, 364, 366, and 368 provide the functionality needed for a biller. Although the preceding description has explained a suitable implementation of the invention in sufficient detail, several additional preferred features, alternative features, and implementation details are discussed below. Again, the features discussed below are exemplary and the invention is to be understood as not limited to these specific features.

A preferred implementation of the present invention is known as EZ RECEIVABLES and is available from J. J. & Associates, Detroit, Mich. Implementations of the present invention have many features including the capabilities to send optional e-mail notification to payers, receive payments with e-mail notification of payments made, and to search, view, and pay bills electronically using credit cards and electronic checks. Advantageously, the preferred implementation features a print option for payment confirmations, interfaces to commonly used AR packages for bills and payments, supports approver and payer roles, provides two-way communication between billers and payers (fee disputes, purchase orders, etc.). Even further, the preferred implementation includes biller configurable account types and payment application policies, offers user interfaces for routine biller tasks such as invoice import, payment exports, etc. Further, a preferred implementation allows payers to search and browse bill and payment history, attach multiple bill-supporting documents, and protect bills and payments with industry standard security features.

Advantageously, preferred embodiments of the present invention provide integration with accounting systems. Preferred embodiments of the present invention include a built-in payment engine. That is, electronic check and credit card payment engines are built-in to provide fast settlement of payment processes. Electronic check payments are enabled by incorporating banking industry standards and processes. The system implements and transmits NACHA (North American Clearance House Association) format files to the bank. Credit card payments are authenticated, authorized and settled instantaneously through well known settlement agencies (for example, Verisign, Cybercash, etc.). In addition, user interfaces are provided to enable businesses to enter payee (biller) bank information into the system.

The preferred embodiments of the present invention utilize multiple payment policies. That is, as alluded to previously, the biller may create different account types for the services provided by the biller and define payment policies for each of the account types based on company policy. Preferably, the following payment policies are included: pay exact amount due against bills, short pay bills, and pay any amount and system prorates and applies payments against oldest open bill first. That is, the system is designed to apply payments in accordance with predetermined payment policies selected by the biller. As mentioned previously, preferred embodiments of the present invention utilize e-mail notification. Further, the preferred embodiments of the present invention have reporting capabilities such that customers may print detailed bills and bill attachments, if any, for their record keeping. In addition, the customer may print payment confirmations. These confirmations may include date, time, mode of payment and amounts.

A preferred embodiment of the invention uses login name and password to authenticate a user. Of course, more sophisticated methods may be employed. In addition, the host has a certificate, client to host communications are encrypted using 40/128 bit SSL encryption, and banking industry norms are used for money transfer.

A preferred implementation of the present invention has many benefits to both billers and to payers. For the payer, registering online and utilizing methods of the present invention may be accomplished with only a few steps. Assuming that the payer has billers that wish to send bills online utilizing the host system, the payer needs to register with the host system. Thereafter, the payer may log on to the system and make payments. Preferably, the payer sets up the accounts payable settings on the host system (possibly using the exemplary web interface described previously). Once the AP system settings have been entered, the payer may download the invoices and payments for importation into the payer's AP system. Setting up the biller's side of the host system, in an exemplary implementation, takes slightly more steps than setting up the payer side.

The following description explains the biller setup for a preferred implementation of the present invention known as EZ RECEIVABLES. In the following description, the setup explanation is tailored to a biller using QUICK BOOKS as the AR system for exemplary purposes. It is appreciated that the setup process may vary as appropriate for other AR systems. In addition, the setup may vary for other implementations of the present invention, and the particular explanation below is exemplary and not limiting.

In a suitable implementation, the biller will download a setup file. The setup file creates several directories and includes the files that are run to upload invoices and attachments to the host system. In the example, file transfer protocol (FTP) is used to send invoices and attachments to the host system; the details of the transfer are apparent to one of ordinary skill in the art from the description herein.

In the example, the setup file is extracted to create one or more text files that explain the biller setup process. Further, both a batch and associated text file are provided for uploading invoices, in addition to both a batch and text file for uploading attachments. Each batch file references the associated text file, which includes appropriate system commands to use FTP to upload the invoices or attachments to the host system. Once the invoice and attachment files are on the host system, the biller, via the web interface, finishes the importation process by running the appropriate job to put the uploaded invoices and attachments into the database. In a suitable implementation, the batch and text file for uploading invoices are placed in an invoice directory, and the batch and text file for uploading attachments are placed in an attachment directory.

Three of the four steps below are to be performed by the biller in the AR system (QUICK BOOKS in this example) to customize the AR system. The 4 steps are: 1) Modify customer names for EZ RECEIVABLES; 2) Create or modify invoice lines to support attachments; 3) Generate invoice file for uploading open invoices into EZ RECEIVABLES; and 4) Create attachment files (performed outside of AR systems).

To modify the customer names for billing using EZ RECEIVABLES, the following menu options are used: Customer−>Customer Job List−>select the customer name, double click on the (customer) field−>edit customer Info. Example: If the customer name is Floyd, and Floyd's identity is 123456789, then change Floyd's name in the system to . . . Floyd/123456789. The identity is the Social Security number for an individual, and the Federal Tax Identification Number for a company.

An attachment is any kind of document that the biller can send along with any invoice. The biller can have one attachment per invoice line. These attachments are scanned or faxed images such as products, purchase orders, time sheets etc. The invoice line item description is modified to include the attachment name within ˜ (tilde) characters.

Continuing with the QUICK BOOKS example, the invoice file for uploading is generated as follows: Select Reports−>Sales−>Sales by Item Detail. Customize the Sales by Item Detail standard report as follows. Click on the Customize button and select the following column headings: Date, Num, PO#, Name, Memo, Qty, and Sales Price. Click on the Filter button, and select Paid Status. Click on Paid Status and choose Open. This ensures that only unpaid or partially paid invoices are extracted.

Click on the Print button and choose the Print to File option. Choose Excel/Lotus123 file type from the drop down list. Click Print; enter file name: <identity >_invoices.prn and put the file in the invoices directory. <identity> is the Social Security number or Federal Tax Identification number, as appropriate. The customized report may be saved for future use.

For each of the invoice lines that have attachments (a scanned image of shippers, timesheets, parts catalogs, etc.), the following needs to be done to create attachment files. Create the attachment image in the jpeg format and save the file as <identify>_<imagename>.jpg, putting the saved file in the attachment directory, doing this for each attachment. <imagename> is the name within the tilde characters in the invoice line.

Now that the client machine is setup and the AR system is customized, biller information must be setup on the host system. In the example, the biller goes to the host system website (for example, www.ezreceivables.com) and logs on as a biller (FIG. 10), bringing up the biller information tab. The biller must fill in company information and account type information (FIG. 11).

Each account type must be entered in the Account Type column as illustrated in the FIG. 11 example. Each account type has a default charge unit. This charge unit is the unit of measure of each of the invoice lines, belonging to the respective account type. i.e. HRS, LBS etc. Also each account type has a Payment Policy Rule. This is the rule that the biller company follows in accepting payments and applying them to the invoices. There are three pre-defined rules that the biller can choose from in the exemplary implementation.

1. Match Invoices—Pay Exact Amount. This rule allows the payer to choose and select the invoices which he/she wants to pay. The payer is forced to pay the full amount of each invoice which he/she selects for payment.

2. Match Invoices—Pay Any Amount. This rule allows the payer to choose and select the invoices which he/she wants to pay. The payer is allowed to pay any amount (less than the invoice amount) against each invoice which he/she selects for payment.

3. Pay any Amount—System prorates oldest open invoice first. This rule does not allow the payer to choose the invoices which he/she wants to pay. The payer can pay any amount and the system automatically applies the amount to the oldest open invoice first.

In addition, bank information for processing electronic checks must be entered by the biller (FIG. 13). And, to complete the online setup for the biller, AR system information (FIG. 14) must be entered for each valid account type, and the jobs administration information (provided by the host system administrator) must be entered (FIG. 17).

Now that the local machine for the biller has been setup, and the biller information has been entered into the host system, the biller may begin using the host system for billing. The below description, for the exemplary implementation, explains how to upload invoices to the host system, send electronic payments to the biller bank, and extract and import received payments. First, the biller (in the QUICK BOOKS example) should generate an invoice file, as explained above, and place the file in the invoice directory (with the invoice batch and text file). Second, the biller should create all attachments, as explained above, and place the jpegs in the attachment directory (with the attachment batch and text file). Next, the invoice file and attachment files are uploaded to a predetermined location at the host system. In the example, the batch files are executed and use file transfer protocol to upload the invoice and attachment files.

Then, the biller should log on and go to the jobs screen (FIG. 17). Pressing button 362 loads the uploaded invoice files into the database. Preferably, a report is generated and shows the following:

1) How many new customers were created, and their default login names and passwords; 2) How many new customer accounts were created; 3) how many new invoices were uploaded; and 4) how many new invoice lines were uploaded. This completes the importing of invoices and attachments to the host system database (EZ RECEIVABLES database).

Pressing button 364 to send electronic check payments to the biller bank, in the example creates a control file and NACHA file on the screen. The control file displays the total amount that will be received by the biller bank. The NACHA file will appear immediately afterwards. This is the electronic payment file in NACHA format that the biller will send to the bank using terminal emulation or equivalent software in accordance with instructions from the biller's bank.

Pressing button 366, as mentioned previously, generates a payment file that may be imported into the in-house accounting system of the biller. In addition, pressing button 366 preferably also generates a payment application report that reports exactly how invoices were applied to payments. In these exemplary embodiments, the payment file includes the payments, but the biller must manually apply the payments to the invoices in accordance with the report. Some A/R systems may allow automatic application of payments. If so, the payment file generated confirms the payment application information in addition to the basic payment information. This file when imported into such an A/R system will automatically apply the payments against invoices, that was the intention of the payer.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of invoice presentation and invoice payment for use in a network accessible to a biller having a biller accounts receivable system and a biller bank, and accessible to a payer having a payer accounts payable system and a payer bank, the method comprising:
establishing a database accessible over the network;
exporting an invoice from the biller accounts receivable system to the database;
presenting the invoice to the payer when the payer accesses the database to view the invoice;
importing the invoice to the payer accounts payable system from the database;
paying the invoice by recording a payment from the payer representing an amount of money, the payment being recorded in the database;
importing the payment to the payer accounts payable system from the database; and
importing the payment to the biller accounts receivable system from the database.

2. The method of claim 1 further comprising:
transmitting the payment from the database to the biller bank.

3. The method of claim 2 further comprising:
transferring the amount of money to the biller bank from the payer bank.

4. The method of claim 3 wherein establishing the database further comprises:
establishing the database such that the database is accessible over the Internet.

5. The method of claim 4 wherein the database is accessible over the network through a web executable interface.

6. The method of claim 5 wherein the web executable interface operates in a virtual machine and wherein the payer starts the virtual machine and interacts with the database from within the virtual machine.

7. The method of claim 6 wherein presenting the invoice to the payer further comprises:
starting the virtual machine at the payer; and
presenting the invoice to the payer with the virtual machine.

8. The method of claim 7 wherein paying the invoice further comprises:
paying the invoice as directed by the payer from within the virtual machine.

9. The method of claim 8 wherein importing the invoice to the payer accounts payable system further comprises:
downloading the invoice from the database as directed by the payer from within the virtual machine; and
importing the downloaded invoice.

10. The method of claim 8 wherein importing the payment to the payer accounts payable system further comprises:
downloading the payment from the database as directed by the payer from within the virtual machine; and
importing the downloaded payment.

11. The method of claim 6 wherein the web executable interface operates in a virtual machine and wherein the biller starts the virtual machine and interacts with the database from within the virtual machine.

12. The method of claim 11 wherein the biller views the recorded payment from within the virtual machine.

13. The method of claim 11 wherein importing the payment to the biller accounts receivable system further comprises:
downloading the payment from the database as directed by the biller from within the virtual machine; and
importing the downloaded payment.

14. The method of claim 11 wherein exporting the invoice from the biller accounts receivable system further comprises:
uploading the invoice as directed by the biller; and
entering the uploaded invoice into the database.

15. The method of claim 14 wherein the invoice has at least one associated attachment, and wherein the method further comprises:
uploading the at least one attachment as directed by the biller; and
entering the uploaded at least one attachment into the database.

16. The method of claim 1 further comprising:
notifying the payer when the invoice is exported from the biller accounts receivable system to the database.

17. The method of claim 16 wherein notifying further comprises:
sending an email to the payer to notify the payer when the invoice is exported from the biller accounts receivable system to the database.

18. The method of claim 1 further comprising:
notifying the biller when the payment is recorded.

19. The method of claim 18 wherein notifying further comprises:
sending an email to the biller to notify the biller when the payment is recorded.

20. The method of claim 1 further comprising:
approving the invoice prior to paying the invoice.

21. The method of claim 1 wherein after the payment is recorded, the method further comprises:
applying the payment to the invoice.

22. The method of claim 21 wherein applying the payment further comprises:
applying the payment to the invoice in accordance with predefined payment rules setup by the biller.
